(19) United States
(12) Patent Application Publication
(10) Pub. No.: US 2005/0179945 A1
(43) Pub. Date: Aug. 18, 2005

(54) System and method for variable text overlay

(75) Inventors: Lena Sojian, Fountain Valley, CA (US); Guy Eden, Tustin, CA (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/777,347

(22) Filed: Feb. 12, 2004

(51) Int. Cl. G06F 15/00

(52) U.S. Cl. 358/1.18; 358/1.12

(57) ABSTRACT

An MFP text overlaying system and method are provided. The method comprises: accepting a document, either in paper media or electronic format; accepting a text overlay message; merging the overlay message with the document; and, creating a merged document. Typically, the product is a paper media merged document. Alternately, the merged document may be transmitted to another node for additional processing. More specifically, accepting a document may include: accepting a paper media document; converting the document to rasterized data; and, generating a first image. Accepting an overlay message may include: accepting an electronically formatted overlay message; converting the overlay message to a Page Description Language (PDL) file; processing the PDL file as a print job; and, generating a second image as rasterized data. Then, the overlay merger process includes: adding the first image to the second image; and, generating a third image.

### BACKGROUND OF THE INVENTION

1. Field of the Invention

This invention generally relates to digital document processing and, more particularly, to a system and method for using a multifunctional peripheral (MFP) device to merge a text message overlay into an independent document.

2. Description of the Related Art

Conventional MFP and copiers do not provide a mechanism that permit a user to add variable text information to the document being copied. For example, if the user wishes to add a timestamp to the document being copied, or add a small title to the top of the document for identification purposes, the user begins with a copy of a document, takes the document to their desk, and manually applies the modifications to the document. For example, the user may cut-and-paste an overlay onto the document. Alternately, the user may take two separate documents to the printer, and arrange the two documents to create a single copy that includes sections of both of the original documents. Either of these processes is cumbersome and time consuming, wasting company time and resources.

It would be advantageous if a process existed for using an MFP to conveniently merge an overlay text message into an independent document.

### SUMMARY OF THE INVENTION

The present invention provides a method to incorporate customized text information into an original document image before the document is printed onto hard copy, or electronically transmitted. A unique aspect of this invention is that the text message is applied to the document BEFORE the document is copied, instead of AFTER.

Suppose the user would like to make a copy of a dinner receipt, and add a description text “Meeting with John Doe, Marketing Director”. The user approaches the copier front panel, and using a stylus pen or liquid crystal display (LCD) panel, virtual keyboard, wireless personal digital assistant (PDA), or smart card, inputs the text message to be applied to the document. The user may also be presented with options to select the page position and style of the message, as it should appear on the copied document. The MFP applies the desired information onto the document being copied before generating the printed output.

In addition to text strings, this invention also permits the user to add fields such as DATE and TIMESTAMP onto the document being copied. For example, the MFP software may extract the current DATE and TIME from the system, and apply the information to the document, before generating the printed output.

Accordingly, an MFP text overlaying method is provided. The method comprises: accepting a document, either in paper media or electronic format; accepting a text overlay message; merging the overlay message with the document; and, creating a merged document. Typically, the product is a paper media merged document. Alternately, the merged document may be transmitted to another node for additional processing.

More specifically, accepting a document may include: accepting a paper media document; converting the document to rasterized data; and, generating a first image. Accepting an overlay message may include: accepting an electronically formatted overlay message; converting the overlay message to a Page Description Language (PDL) file; processing the PDL file as a print job; and, generating a second image as rasterized data. Then, the overlay merger process includes: adding the first image to the second image; and, generating a third image.

Merging the overlay message with the document may include the selection of the overlay message position with respect to the document position, and/or the selection message characteristics such as message size, message shape, font, color, or print options.

Additional details of the above-described method and an MFP text overlay system are provided below.

### BRIEF DESCRIPTION OF THE DRAWINGS

FIG. 1 is a schematic block diagram illustrating the present invention MFP with a text overlaying system.

FIG. 2 is a flowchart illustrating the present invention text overlay merger process.

FIG. 3 is an exemplary text overlay message.

FIG. 4 is a flowchart illustrating another aspect of the present invention MFP text overlaying method.

### DETAILED DESCRIPTION OF THE PREFERRED EMBODIMENTS

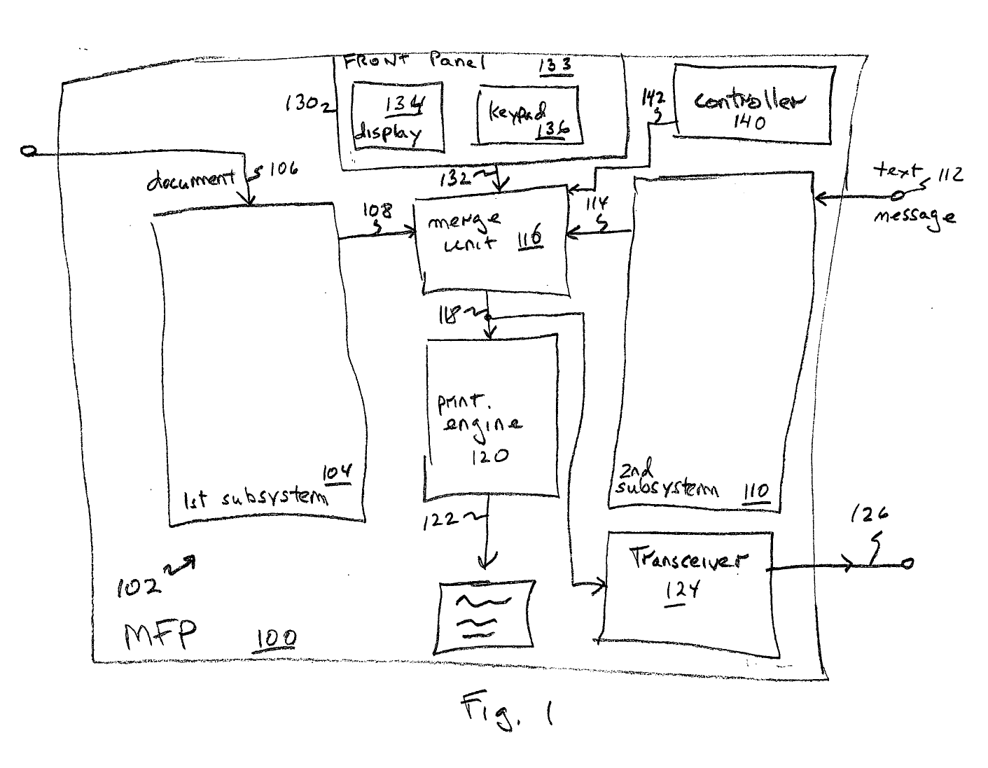

FIG. 1 is a schematic block diagram illustrating the present invention MFP 100 with a text overlaying system 102. The system 102 comprises a first subsystem 104 having an interface on line 106 to accept a document and an interface on line 108 to supply document rasterized data. A second subsystem 110 has an interface on line 112 to accept a text overlay message and an interface on line 114 to supply overlay rasterized data. A merge unit 116 has an interface on line 108 to accept the document rasterized data and an interface on line 114 to accept overlay rasterized data. The merge unit 116 merges the overlay message with the document and supplies a merged document at an interface on line 118.

In one aspect of the system 102, a print engine 120 has an interface on line 118 to accept the merged document and an interface on line 122 to supply a paper media merged document. In other aspects, the system 102 includes a transceiver 124 having an interface on line 118 to accept the merged document and a network-connected interface on line 126 to electronically transmit the merged document. For example, the MFP may be locally connected, or connected through a local area network (LAN) to another node, such as a personal computer or server, that may perform additional processes on the merged document.

The first subsystem 104 accepts either a paper media document, in which case the MFP may be operating as a copier or scanner, or an electronically formatted document, in which case the MFP may be operating as a printer. The electronically formatted documents may be either text documents, such as documents in a Word format, or image documents, such as in a portable document format (PDF). Note, the system is not limited to any particular type of document format. As used herein, an MFP is a device that may be capable of performing copying, printing, scanning, and fax operations.

In one aspect, the first subsystem 104 is a copier pipeline that accepts a paper media document and generates a first image of rasterized data. The second subsystem 110 is a print pipeline accepting an electronically formatted overlay message. The print pipeline 110 converts the overlay message to a Page Description Language (PDL) file, and processes the PDL file as a print job, to generate a second image of rasterized data. The overlay message PDL file may be in Printer Control Language (PCL) or PostScript (PS) for example. Then, the merge unit 116 adds the first image to the second image, and generates a third image supplied on line 118.

In some aspects, the merge unit 116 has a user interface (UI) 130 to accept position commands on line 132. The merge unit 116 positions the overlay message with respect to the document, in response to the position commands. The merge unit UI 130 may also accept message characteristics selection commands such as message size, message shape, font, color, or print options. Again, the merge unit 116 modifies the overlay message in response to the selected message characteristics.

In one aspect, the merge unit UI 130 is enabled as an MFP front panel 133, including a display 134 and keypad 136. For example, the MFP front panel UI 130 may display an image of the document (on display 134) and supply prompts for superimposing the overlay message on the document. The UI 130 may accept user commands via the keypad 136. Then, the merge unit 116 positions the overlay message in response to the commands accepted at the MFP front panel UI 130. Note, the MFP front panel 133 may include different or additional interfaces. The present invention is not limited to any particular type of UI interface.

The second subsystem 110 accepts overlay messages on line 112 via a plurality of interface mechanisms (not shown), such as an MFP scanner, a stylus, or a virtual keyboard that may be associated with display 134. In other aspects, the overlay message may be accepted via a smart card or wireless personal digital assistant (PDA) interface. Other conventional means of inputting text data are known that would also be applicable to the present invention system.

In another aspect, an MFP controller 140 has an interface on line 142 to supply an ASCII code timestamp, including a date and time. The second subsystem 110 accepts the timestamp from the MFP controller 140, converts the ASCII code to a PDL file, and generates a rasterized overlay timestamp message. The MFP controller 140 may also supply dynamic data, such as document page count, timestamp, MFP name, or MFP identification (ID), to name but a few examples. Then, the merge unit 116 accepts the dynamic data and additionally merges the dynamic data with the document.

Note, the above-described system may be enabled using hardware or software elements, where a software element is understood to a list of microprocessor instructions that are stored in memory.

### Functional Description

In one aspect, the MFP includes a front panel for system/job configuration, a scanner (copy pipeline) for copying, a print pipeline for printing, and a print engine for printing the output onto hard copy. The scan and print functions are typically performed as separate pipelines, with the output of both pipelines being rasterized data.

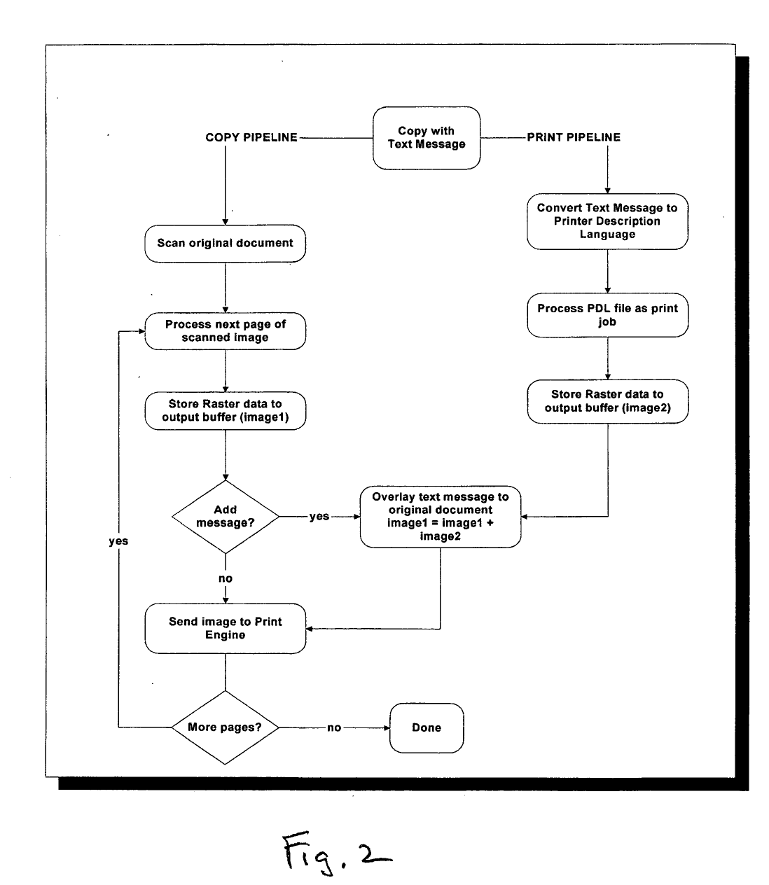

FIG. 2 is a flowchart illustrating the present invention text overlay merger process. The present invention uses the scan (copy) pipeline for generating raster data of the original document, and the print pipeline for generating raster data of the text message to be applied to the document being copied. The raster images of both pipelines are combined into one image before being sent to the print engine.

To process the text message through the print pipeline, the text message is converted to an appropriate Printer Description Language (PDL) and submitted to the print pipeline for processing. The PDL may be PCL, PostScript, or any other conventional language that may be supported by the print pipeline.

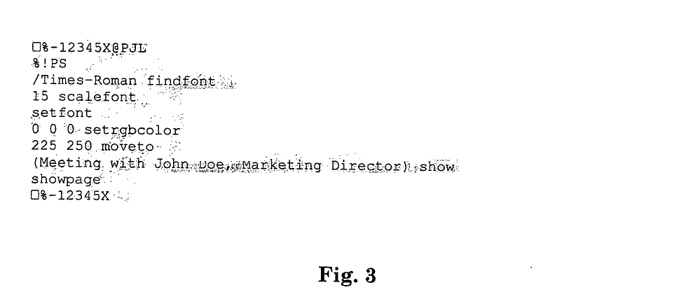

FIG. 3 is an exemplary text overlay message. The figure is an example of the PostScript code generated for displaying the text “Meeting with John Doe, Marketing Director”. After the message is converted to PostScript, the PostScript program is processed via the print pipeline. A raster image of the text message is generated that can be combined with the raster image of the original document.

In the above example, fixed coordinates and fonts are used for the printed text message. In another aspect, the user is presented with options for selecting the style and position of the text. Then, software automatically generates the appropriate PDL code to match the user selection.

To process fields such as TIMESTAMP, the software may extract the current DATE and TIME values from the system controller, convert the values to ASCII strings. Then, the appropriate PDL code is generated for the ASCII representation of the DATE and TIME.

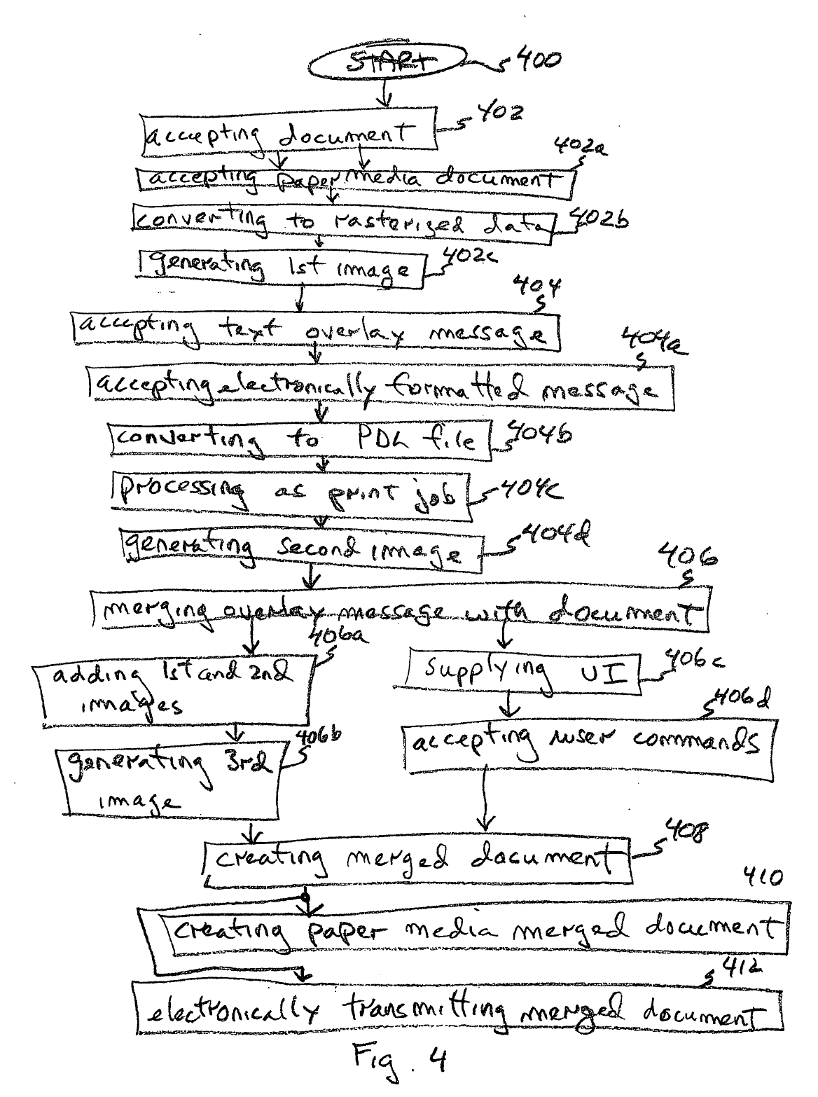

FIG. 4 is a flowchart illustrating another aspect of the present invention MFP text overlaying method. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 400.

Step 402 accepts a document. The document may be either a paper media document or an electronically formatted document. If electronically formatted, the document may be either a text or image document. Step 404 accepts a text overlay message. Step 406 merges the overlay message with the document. Step 408 creates a merged document. In one aspect, Step 410 creates a paper media merged document. Alternately, Step 412 electronically transmits the merged document.

In one aspect, accepting a document in Step 402 may include substeps. Step 402a accepts a paper media document. Step 402b converts the document to rasterized data. Step 402c generates a first image. Likewise, accepting an overlay message in Step 404 may include substeps. Step 404a accepts an electronically formatted overlay message. Step 404b converts the overlay message to a PDL file, such as PCL or PS. Step 404c processes the PDL file as a print job. Step 404d generates a second image as rasterized data. Then, merging the overlay message with the document (Step 406) includes substeps. Step 406a adds the first image to the second image. Step 406b generates a third image. If the merged document is printed (Step 410), it is sent to an MFP print engine.

In one aspect, merging the overlay message with the document (Step 406) includes accepting position commands for positioning the overlay message position with respect to the document. In other aspects, Step 406 accepts message characteristic selection commands concerning the message size, message shape, font, color, or other print options.

More specifically, accepting message characteristics selection commands may include substeps. Step 406c supplies user interface (UI) message characterization prompts at an MFP front panel. Step 406d accepts user commands from the UI.

In another aspect, the step of accepting position commands may include substeps (not shown). Step 406e presents an image of the document on an MFP display. Step 406f supplies prompts for superimposing the overlay message on the document using a UI associated with the display. Step 406g receives user commands on the UI. Step 406h positions the overlay message in response to the commands.

In one aspect, accepting an overlay message (Step 404) includes the substeps (not shown) of: receiving an ASCII code timestamp, including a date and time, from an MFP controller; converting the ASCII code to a timestamp PDL file; and, generating a rasterized overlay timestamp message. In a different aspect, a further step, Step 405 (not shown) generates dynamic data, such as document page count, timestamp, MFP name, or MFP ID. Then, Step 406 additionally merges the dynamic data with the document.

In another aspect, accepting an overlay message (Step 404) includes accepting an overlay message from an interface selected from the group including a scanner, stylus, smart card, virtual keyboard, and wireless personal digital assistant (PDA) interface.

A system and method have been providing for using an MFP to merge a text overlay message into a document. A few examples have been provided of options that can be used to speed and/or add value to the process. However, the invention may be enabled using other features. Other variations and embodiments of the invention will occur to those skilled in the art.

1. In a multifunctional peripheral (MFP), a text overlaying method comprising:
accepting a document;
accepting a text overlay message;
merging the overlay message with the document; and,
creating a merged document.

2. The method of claim 1 further comprising:
creating a paper media merged document.

3. The method of claim 1 wherein accepting a document includes accepting a document selected from the group including paper media and electronically formatted documents.

4. The method of claim 3 wherein accepting an electronically formatted document includes accepting a document selected from the group including text and image documents.

5. The method of claim 1 further comprising:
electronically transmitting the merged document.

6. The method of claim 2 wherein accepting a document includes:
accepting a paper media document;
converting the document to rasterized data; and,
generating a first image;
wherein accepting an overlay message includes:
accepting an electronically formatted overlay message;
converting the overlay message to a Page Description Language (PDL) file;
processing the PDL file as a print job; and,
generating a second image as rasterized data.

7. The method of claim 6 wherein merging the overlay message with the document includes:
adding the first image to the second image; and,
generating a third image.

8. The method of claim 7 wherein printing the merged document includes sending the third image to an MFP print engine.

9. The method of claim 6 wherein converting the overlay message to a PDL file includes converting the overlay message to a PDL file selected from the group including Printer Control Language (PCL) and PostScript (PS).

10. The method of claim 1 wherein merging the overlay message with the document includes accepting position commands for positioning the overlay message with respect to the document.

11. The method of claim 10 wherein merging the overlay message with the document includes accepting message characteristics selection commands chosen from the group including message size, message shape, font, color, and print options.

12. The method of claim 11 wherein accepting message characteristics selection commands includes:
supplying user interface (UI) message characterization prompts at an MFP front panel; and,
accepting user commands from the UI.

13. The method of claim 10 wherein accepting position commands for positioning the overlay message with respect to the document includes:
on an MFP display, presenting an image of the document;
using a UI associated with the display, supplying prompts for superimposing the overlay message on the document;
receiving user commands on the UI;
positioning the overlay message in response to the commands.

14. The method of claim 1 wherein accepting an overlay message includes:
receiving an ASCII code timestamp, including a date and time, from an MFP controller;
converting the ASCII code to a timestamp PDL file; and,
generating a rasterized overlay timestamp message.

15. The method of claim 1 wherein accepting an overlay message includes accepting an overlay message from an interface selected from the group including a scanner, stylus, smart card, virtual keyboard, and wireless personal digital assistant (PDA) interface.

16. The method of claim 1 further comprising:
generating dynamic data selected from the group including document page count, timestamp, MFP name, and MFP identification (ID); and,
wherein merging the overlay message with the document includes additionally merging the dynamic data with the document.

17. In a multifunctional peripheral (MFP), a text overlaying system comprising:
a first subsystem having an interface to accept a document and an interface to supply document rasterized data;
a second subsystem having an interface to accept a text overlay message and an interface to supply overlay rasterized data; and,
a merge unit having an interface to accept the document rasterized data, an interface to accept overlay rasterized data, the merge unit merging the overlay message with the document and supplying a merged document at an interface.

18. The system of claim 17 further comprising:
a print engine having an interface to accept the merged document and an interface to supply a paper media merged document.

19. The system of claim 17 wherein the first subsystem accepts a document selected from the group including paper media and electronically formatted documents.

20. The system of claim 19 wherein the first subsystem accepts an electronically formatted document selected from the group including text and image documents.

21. The system of claim 17 further comprising:
a transceiver having an interface to accept the merged document and a network-connected interface to electronically transmit the merged document.

22. The system of claim 18 wherein the first subsystem is a copier pipeline accepting a paper media document and generating a first image of rasterized data; and,
wherein the second subsystem is a print pipeline accepting an electronically formatted overlay message, the print pipeline converting the overlay message to a Page Description Language (PDL) file, and processing the PDL file as a print job, to generate a second image of rasterized data.

23. The system of claim 22 wherein the merge unit adds the first image to the second image, and generates a third image.

24. The system of claim 22 wherein the print pipeline converts the overlay message to a PDL file selected from the group including Printer Control Language (PCL) and PostScript (PS).

25. The system of claim 17 wherein the merge unit has a user interface (UI) to accept position commands, and positions the overlay message position with respect to the document position, in response to the position commands.

26. The system of claim 25 wherein the merge unit UI accepts message characteristics selection commands chosen from the group including message size, message shape, font, color, and print options, and modifies the overlay message in response to the selected message characteristics.

27. The system of claim 26 wherein the merge unit UI is enabled as an MFP front panel, including a display and keypad.

28. The system of claim 27 wherein the MFP front panel UI displays an image of the document, supplies prompts for superimposing the overlay message on the document, and accepts user commands; and,
wherein the merge unit positions the overlay message in response to the commands accepted at the MFP front panel UI.

29. The system of claim 17 further comprising:
an MFP controller having an interface to supply an ASCII code timestamp, including a date and time; and,
wherein the second subsystem accepts the timestamp from the MFP controller, converts the ASCII code to a PDL file, and generates a rasterized overlay timestamp message.

30. The system of claim 17 wherein the second subsystem accepts overlay messages using an interface selected from the group including a scanner, stylus, smart card, virtual keyboard, and wireless personal digital assistant (PDA) interfaces.

31. The method of claim 17 further comprising:
an MFP controller having an interface to supply dynamic data selected from the group including document page count, timestamp, MFP name, and MFP identification (ID); and,
wherein the merge unit has an interface to accept the dynamic data and additionally merges the dynamic data with the document.
